(19) United States
(12) Patent Application Publication
(10) Pub. No.: US 2017/0262911 A1
(43) Pub. Date: Sep. 14, 2017

(54) CLOUD SERVICE RATING

(71) Applicant: HEWLETT PACKARD ENTERPRISE DEVELOPMENT LP, Houston, TX (US)

(72) Inventor: Kishore Jagannath, Bangalore (IN)

(21) Appl. No.: 15/528,723

(22) PCT Filed: Jun. 30, 2015
(86) PCT No.: PCT/US2015/038545

§ 371 Date: May 22, 2017

(30) Foreign Application Priority Data
Dec. 5, 2014 (IN) 6128/CHE/2014

(51) Int. Cl. G06Q 30/06

(52) U.S. Cl. CPC G06Q 30/0601

(57) ABSTRACT

According to an example, to provide cloud service ratings, a service type is monitored on a first and second cloud service by capturing on a network interface at least one resource utilization feed and at least one connection feed. Infrastructure-level metrics and application-level metrics for the service type on the first and second cloud services are determined based on the monitoring of the first and second cloud services. Cost information for the service type on the first and second cloud services is fetched. A rating for the service type on the first cloud service and a rating for the service type on the second cloud service are calculated based a weighting of the infrastructure-level metrics, the application-level metrics, and the cost information.

### BACKGROUND

Cloud computing services have become an increasingly popular alternative to purchasing and maintaining computer equipment locally, particularly at the enterprise level. The cloud computing market now includes a myriad of service types and service levels of varying scope, scalability, performance, and reliability.

### BRIEF DESCRIPTION OF THE DRAWINGS

FIG. 1 illustrates a cloud system including a broker, cloud services, and a customer, according to an example of the present disclosure;

FIG. 2 illustrates a flowchart of providing a rating for a cloud service, according to an example of the present disclosure;

FIG. 3 illustrates a flowchart of receiving a rating request for a cloud service, according to an example of the present disclosure; and

FIG. 4 illustrates a schematic representation of a computing device that may be used as a platform for implementing or executing at least one of the processes depicted in FIGS. 2-3, according to an example of the present disclosure.

### DETAILED DESCRIPTION

Various embodiments described below provide cloud service ratings to a user based on data feeds, infrastructure-level metrics, application-level metrics, cost information, user preferences, and user feedback. Metrics may include, for example, uptime, scalability, CPU performance data, memory performance data, hard disk performance data, bandwidth, connection pool data, HTTP response time data, memory usage, and other data sourced from the feeds.

Cloud computing services (hereinafter simply “cloud services”) may comprise servers, databases, networking equipment, and other computing equipment maintained by a cloud computing provider, commonly referred to as a cloud service provider or CSP. Cloud services may include virtual machines or other distributed processing systems that may be used to host servers, websites, applications, databases, and other cloud-based software in the consumer, commercial, and industrial sectors.

Cloud services may be accessed by computing systems, devices, and electronic components such as desktop computers, laptop computers, servers, thin clients, tablets, smartphones, digital video recorders, retail point of sale devices, and other computing equipment (hereinafter “device” or “devices”). Access may be provided via public or private networks, such as the internet or intranets.

In response to the demand for cloud services, various cloud services on a myriad of platforms and of differing quality and service levels have emerged, with options intended for a variety of budgets and requirements. For example, one cloud service may provide cloud servers running on Windows operating systems with a particular database type and a service level guarantee of 98% uptime, while another cloud service may provide cloud servers running on Linux operating systems with a different database, and a service level guarantee of 99.9% uptime with global redundancy.

In addition to the general availability, performance, and scalability of a cloud service, hundreds of other parameters and/or metrics can be monitored and/or analyzed to compare services depending on the needs of a cloud computing user and the depth with which a cloud computing user wishes to compare cloud services. For example, service level guarantees can be monitored not only at the server level, but as deep as at the infrastructure level or the application level.

As some examples of monitoring or analysis at the infrastructure level, uptime, scalability, CPU performance data, memory performance data, hard disk performance data, and bandwidth data can be monitored. As examples at the application-level, connection pool data, HTTP response time data, and memory usage data may be monitored.

Moreover, depending on the application intended to be run on a cloud service, various metrics may be more or less important to a particular user. For example, a cloud service intended to perform encryption routines may require high CPU and hard disk performance, but may be less sensitive to bandwidth and uptime. In another example, a cloud service intended to process financial transactions such as stock trades may be highly sensitive to HTTP response time at the millisecond level. In yet another example, a cloud service intended to host medical information may be highly sensitive to uptime.

In all of these examples, a user may also seek metrics with respect to a particular service type on a cloud service, such as a particular database or a particular application. For example, a user may seek metrics on the performance of the LAMP stack across two or more cloud services.

In addition to service metrics, a user may also seek cost information. For example, the user may seek the hourly, daily, or monthly cost of a cloud service, grouped by the service type. For example, the LAMP stack may be a feature available on a cloud service at a certain price with a certain performance metric.

Given the complexity and sheer number of metrics, cost data, and in some examples user feedback involved in the decision process of choosing an appropriate cloud service, a user may also seek a single or aggregated rating of cloud services based on metric, cost, and other data appropriate or weighed for the user's needs.

According to an example of providing cloud service ratings, a service type is monitored on a first and second cloud service by capturing on a network interface at least one resource utilization feed and at least one connection feed via a communication protocol. Infrastructure-level metrics and application-level metrics for the service type on the first and second cloud services are determined based on the monitoring of the first and second cloud services. Cost information for the service type on the first and second cloud services is fetched. A rating for the service type on the first cloud service and a rating for the service type on the second cloud service are calculated based on a weighting of the infrastructure-level metrics, the application-level metrics, and the cost information.

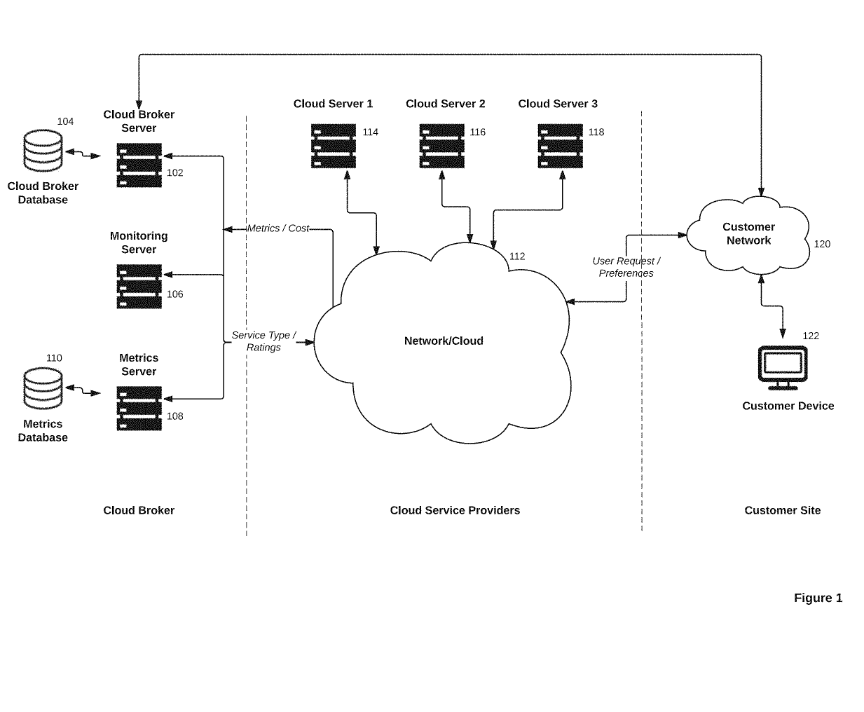

FIG. 1 illustrates a cloud system including a broker, cloud service, and customer, according to an example of the present disclosure.

In an example, the cloud broker includes a cloud broker server 102 which may be coupled to a cloud broker database 104. Server 102 and database 104 may receive, calculate, and/or store data related to various cloud services, such as names, descriptions, service types, features, service level guarantees, costs, terms and conditions, and other information.

Monitoring server 106 may be configured to monitor cloud servers, discussed in more detail below. In some examples, users of the monitored cloud servers may grant permission or opt-in to be monitored by monitoring server 106.

Metrics server 108 may be coupled to metrics database 110. Server 108 and database 110 may receive, calculate, and/or store data related to various cloud services. In some examples, metrics server 108 may receive data generated on monitoring server 106.

Network or cloud 112 may connect the cloud broker with cloud service providers and customers, discussed in more detail below. Network or cloud 112 may be any public or private network such as the internet or intranets.

Cloud servers 114, 116, and 118 may represent any cloud service available through, e.g., cloud broker 102. Various service types may run on cloud servers 114, 116, and 118. For example, cloud servers 114, 116, and 118 may offer web host, database, and/or application service types.

Customer device 122 may be any device such as a computer used by a customer or potential customer to access cloud broker server 102. Cloud broker server 102 may transmit to customer device 122, or to the customer in general, a rating or ratings for cloud services, such as those services provided by cloud servers 114, 116, and 118. The rating may be calculated based on metrics, cost, and other data, as discussed above and as described below in more detail.

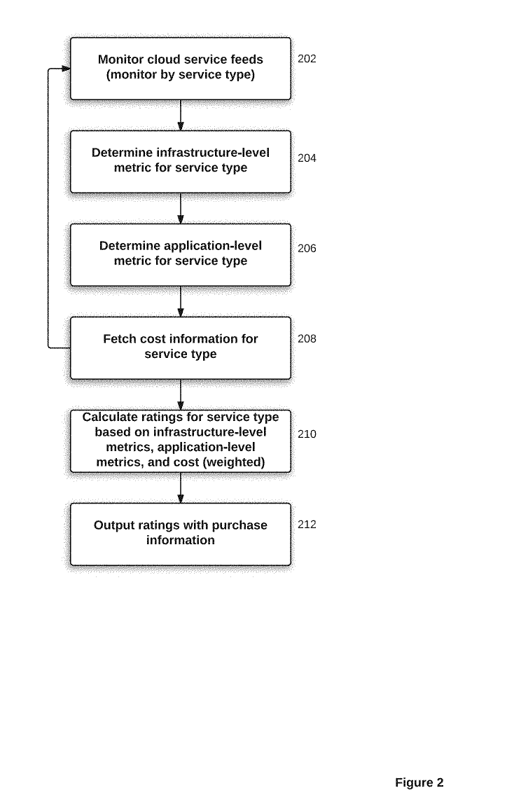

FIG. 2 illustrates a flowchart of providing a rating for a cloud service, according to an example of the present disclosure. In block 202, cloud service monitoring is invoked. The monitoring may be invoked by cloud broker server 102 and/or monitoring server 106 when a customer opts-in to monitoring, or if a cloud services provider opts-in. Monitoring may be at a cloud service level, or grouped by service type, e.g., by database, webhost, application, or other service types on a particular server. In some examples, monitoring may also be grouped geographically.

Monitoring may include capturing resource utilization feeds and connection feeds from a cloud service. Resource utilization feeds may be, for example, raw data captured relating to the performance of a computer system, networking system, or infrastructure component relating to the utilization of a system resource by a program, process, or service enabled on a device. Connection feeds may be, for example, raw data captured relating to the performance or response time of a particular connection, application, or program running on a device or particular platform.

Resource utilization feeds and connection feeds may be captured using a software monitoring tool directly linked to a service or application such as at the operating system level; a network packet capture tool sitting on a connection path; or another tool for capturing or receiving data and/or network traffic. Communication protocols including, but not limited to, TCP/IP, HTTP, Ethernet, WiFi, and USB may be used to allow for the capture and/or receipt of the resource utilization feeds and connection feeds. In some examples, the feeds may be stored and accessed in historical form, as opposed to a live feed. In other examples, the feeds may be captured by another server and provided in aggregate form.

In block 204, at least one infrastructure-level metric for a given service type is determined, calculated, fetched, or otherwise obtained, such as from the feeds discussed above. An infrastructure-level metric may be, for example, uptime, scalability, CPU performance data, memory performance data, hard disk performance data, or bandwidth data.

In block 206, at least one application-level metric for a given service type is determined, calculated, fetched, or otherwise obtained, such as from the feeds discussed above. An application-level metric may be, for example, connection pool data, HTTP response time data, or memory usage.

In block 208, cost information may be determined, calculated, fetched, or otherwise obtained for the service type on the cloud service. Cost information may be grouped by hour, day, or month, and may be further broken down by other factors such as the service level guarantee for a particular service type. In an example, cost data may be transmitted from a cloud service, e.g., from cloud servers 114, 116, or 118 directly to a cloud service broker, e.g., to cloud broker database 104. In another example, cost data may be scraped from an external source such as a publicly-available website or an invoicing system by a server such as cloud broker server 102.

Blocks 202 through 208 may loop as necessary to receive data from multiple cloud services, or multiple service types, or multiple service types on multiple services. The data obtained or stored in blocks 202 through 208 may also be aggregated or averaged.

In block 210, a rating is calculated for each service type on the cloud service based on a combination of the infrastructure-level metrics, application-level metrics, and cost.

In some examples, user preferences are also fetched and factored into the rating. User preferences may be input by customer 122 on, for example, a checkbox or options screen provided by cloud broker server 102. For example, a user may have indicated that a particular application-level metric is more important than another application-level metric due to the particular user's computing needs, and those metrics will be weighted accordingly in block 210. In another example, a user may have weighted cost more heavily than either the application-level metrics or infrastructure-level metrics, or geographical location of the servers.

As an example of the user preferences that may be fetched, referring to the examples above, a user seeking ratings on cloud services intended to perform encryption routines may indicate that high CPU and hard disk performance are to be weighted heavily, but may weight bandwidth and uptime less heavily. In another example, a user seeking ratings on cloud services intended to process financial transactions such as stock trades may indicate that HTTP response times are to be weighted heavily. In yet another example, a user seeking ratings on cloud services intended to host medical information may indicate that uptime is paramount and may set a threshold for uptime, along with a weighting for uptime levels above that threshold.

In some examples, user feedback may also be fetched and factored into the rating in block 210. For example, users may provide feedback on particular attributes of a cloud service or service type to cloud broker server, such as subjective feedback on technical support, that may not otherwise be represented in metrics available to the cloud broker.

In block 212, the ratings for each cloud service and/or service type are output with purchase information and/or an electronic purchase option such as a uniform resource locator or an electronic contract to be executed with a digital signature. In an example, the rating and electronic purchase option may be output to a customer device 122. In some examples, the ratings may be on a scale of 1-10 or 1-100, while in other examples the ratings may follow a letter scale.

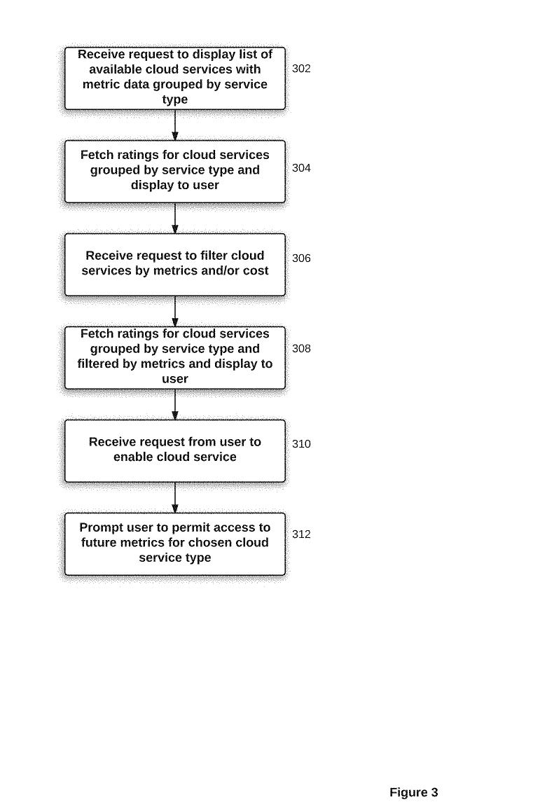

FIG. 3 illustrates a flowchart of receiving a rating request for a cloud service, according to an example of the present disclosure.

In an example, in block 302, a request from a user is received for a list of available cloud services with metric data grouped by service type. For example, the user may request to see a list of all cloud services offering a particular database format, or a particular application type.

In block 304, ratings for the cloud services are fetched, grouped by the service type requested by the user. The ratings are displayed to the user, e.g., at customer device 122.

In block 306, a request is received from the user to filter the cloud services by performance metrics and/or cost, and in block 308 the filtered ratings are received.

In blocks 310 and 312, after a user has chosen a cloud service, the service is enabled and the user is prompted to opt-in to the monitoring tool, e.g., monitoring server 106. Opting-in to the monitoring tool may enable or improve the accuracy of the monitoring tool and metrics discussed herein.

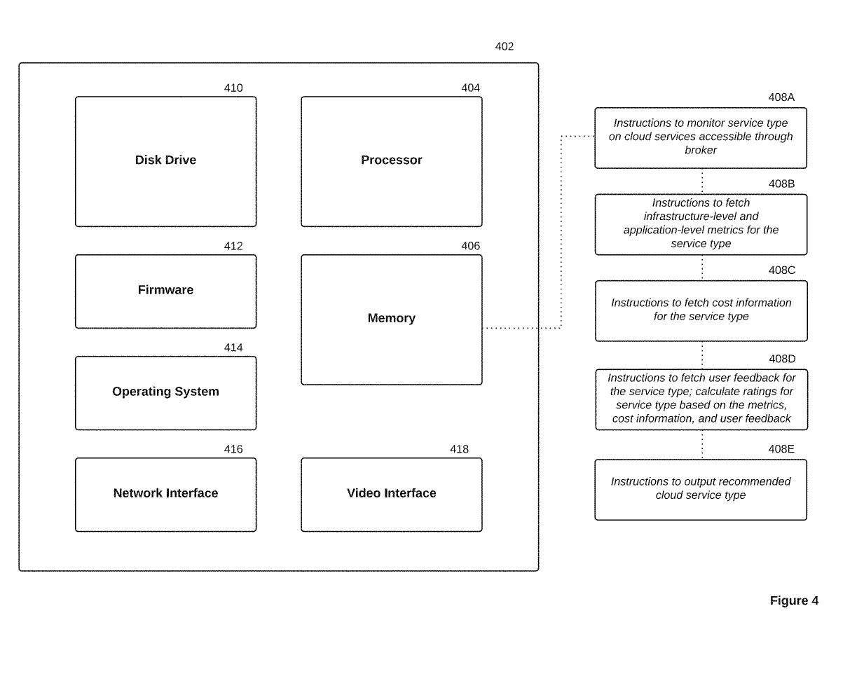

FIG. 4 illustrates a schematic representation of a computing device that may be used as a platform for implementing or executing at least one of the processes depicted in FIGS. 2-3 according to an example of the present disclosure.

In an example, device 402 comprises a processor 404 such as a central processing unit; a memory 406 such as RAM, ROM, or Flash memory; a disk drive 410 such as a hard disk drive or a solid state disk drive; a firmware 412; an operating system 414; and a network interface 416 such as a Local Area Network LAN card, a wireless 802.11x LAN card, a 3G or 4G mobile WAN, or a WiMax WAN card. Each of these components may be operatively coupled to a bus.

Some or all of the operations set forth in the figures may be contained as a utility, program, or subprogram in any desired computer readable storage medium, or embedded on hardware. The computer readable medium may be any suitable medium that participates in providing instructions to the processor 404 for execution. For example, the computer readable medium may be non-volatile media, such as an optical or a magnetic disk, or volatile media, such as memory. The computer readable medium may also store other machine-readable instructions, including instructions downloaded from a network or the internet.

In addition, the operations may be embodied by machine-readable instructions. For example, they may exist as machine-readable instructions in source code, object code, executable code, or other formats.

Device 402 may comprise, for example, a computer readable medium that may comprise instructions 408A-E to monitor a service type on cloud services accessible through broker; fetch infrastructure-level and application-level metrics for the service type; fetch cost information for the service type; fetch user feedback for the service type; calculate ratings for the service type based on the metrics, cost information, and/or user feedback; and output a recommended cloud service type.

The computer-readable medium may also store an operating system such as Microsoft Windows, Mac OS, Unix, or Linux; network applications such as network interfaces and/or cloud interfaces; and a cloud broker service, monitoring tool, or metrics tool, for example. The operating system may be multi-user, multiprocessing, multitasking, and/or multithreading. The operating system may also perform basic tasks such as recognizing input from input devices, such as a keyboard or a keypad; sending output to a display; keeping track of files and directories on a medium; controlling peripheral devices, such as drives, printers, or image capture devices; and/or managing traffic on a bus. The network applications may include various components for establishing and maintaining network connections, such as machine readable instructions for implementing communication protocols including, but not limited to, TCP/IP, HTTP, Ethernet, USB, and FireWire.

In certain examples, some or all of the processes performed herein may be integrated into the operating system. In certain examples, the processes may be at least partially implemented in digital electronic circuitry, in computer hardware, in machine readable instructions (such as firmware and/or software), or in any combination thereof.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method of providing cloud service ratings, comprising:
monitoring a service type on a first cloud service and a second cloud service by capturing on a network interface at least one resource utilization feed and at least one connection feed via a communication protocol;
determining an infrastructure-level metric and an application-level metric for the service type on the first cloud service based on the monitoring of the first cloud service and storing the infrastructure-level metric and the application-level metric for the first cloud service in a database;
determining an infrastructure-level metric and an application-level metric for the service type on the second cloud service based on the monitoring of the second cloud service and storing the infrastructure-level metric and the application-level metric for the second cloud service in the database;
fetching cost information for the service type on the first cloud service and the second cloud service from a database of cost information;
calculating, on a processor, a rating for the service type on the first cloud service and a rating for the service type on the second cloud service based on a weighting of the infrastructure-level metric and the application-level metric for the service type on the first cloud service, the infrastructure-level metric and the application-level metric for the service type on the second cloud service, and the cost information; and
transmitting the rating for the service type of the first cloud service and the rating for the service type of the second cloud service to a user with an electronic purchase option for the first cloud service and the second cloud service.

2. The method according to claim 1, wherein calculating the rating for the service type on the first cloud service and the rating for the service type on the second cloud service further comprises fetching a user preference associated with the service type.

3. The method according to claim 1, wherein the service type comprises at least one of an infrastructure as a service, a software as a service, and a platform as a service.

4. The method according to claim 1, wherein the infrastructure-level metric comprises at least one of uptime, scalability, CPU performance data, memory performance data, hard disk performance data, and bandwidth data.

5. The method according to claim 1, wherein the application-level metric comprises at least one of connection pool data, HTTP response time data, and memory usage data.

6. The method according to claim 1, wherein the purchase information for the first cloud service and the second cloud service is provided through a cloud broker service.

7. A system for providing cloud service ratings, the system comprising a processing resource in communication with a network interface and a computer readable medium, wherein the computer readable medium contains a set of instructions and wherein the processing unit is designed to carry out a set of instructions to:
receive, at the network interface, user preference parameters from a user and cloud service quality metrics and cost information from at least two cloud services;
calculate a rating for at least one service type on the at least two cloud services based on a weighting of the user preference parameters, the cloud service quality metrics, and the cost information; and
transmit the rating and a cloud service recommendation to the user.

8. The system according to claim 7, wherein the network interface is to receive user feedback related to cloud service technical support for the at least one service type.

9. The system according to claim 7, wherein the user preference parameters comprise at least one of an intended use, an operating system type, an application type, a geographic location, and a service-level type.

10. The system according to claim 7, wherein the cloud service quality metrics comprise at least one of performance data and uptime data.

11. The system according to claim 7, wherein the recommendation to the user is based on the rating of the at least one service type.

12. A non-transitory computer readable storage medium on which is embedded a computer program, said computer program to calculate cloud service ratings, said computer program comprising a set of instructions to:
monitor a service type on at least two cloud services that have granted permission to be monitored and are accessible through a cloud service broker;
fetch an infrastructure-level metric and an application-level metric for the service type on the at least two cloud services;
fetch cost information for the service type on the at least two cloud services;
fetch user feedback related to technical support for the service type on the at least two cloud services;
calculate ratings for the service type on the at least two cloud services based on the infrastructure-level metrics and the application-level metrics for the service type, the cost information, and the user feedback; and
output a recommended cloud service for the service type based on the ratings.

13. The computer readable storage medium according to claim 12, wherein the recommended cloud service is output to a cloud service broker.

14. The computer readable storage medium according to claim 13, wherein the cloud service broker comprises a subscription option.

15. The computer readable storage medium according to claim 12, wherein the cost information is grouped by hour, day, and month.
